(19) United States
(12) Patent Application Publication
(10) Pub. No.: US 2009/0257067 A1
(43) Pub. Date: Oct. 15, 2009

(54) Dynamic Air Turbulence Compensation for Laser Measurement Apparatus

(75) Inventors: Mark Adrian Vincent Chapman, Wotton-Under-Edge (GB); Raymond John Chaney, Berkeley (GB); Sergey Loukianov, Stroud (GB)

Correspondence Address: OLIFF & BERRIDGE, PLC, P.O. BOX 320850, ALEXANDRIA, VA, 22320-4850, US

(73) Assignee: RENISHAW PLC, Wotton-Under-Edge (GB)

(21) Appl. No.: 12/083,550

(22) PCT Filed: Nov. 20, 2006
(86) PCT No.: PCT/GB2006/004323

§ 371 Date: Apr. 14, 2008

(30) Foreign Application Priority Data
Nov. 18, 2005 (GB) 0523455.4

(51) Int. Cl. G01B 11/14; G01B 9/02

(52) U.S. Cl. 356/498

(57) ABSTRACT

Measurement apparatus comprising a laser measuring system an acoustic system is described. The apparatus provides a feedback control signal that can be used in the feedback control system of an associated machine. To allow real time, dynamic, operation the laser measurements are compensated using a compensation value derived from a plurality of laser measurements and at least one acoustic time of flight value.

The present invention relates to a method and apparatus for laser measurements. In particular, the invention relates to measurement apparatus that comprises a laser interferometer and an acoustic time of flight measurement system.

It is known that laser interferometer position measurements carried out in air normally suffer from air turbulence induced noise. This noise reduces the stability of laser position feedback. This noise can be reduced by enclosing the laser beams inside “still air” tubes, but this is often impractical due to space constraints. It can also be reduced by unifying/stabilising the atmospheric conditions by use of very high performance air conditioning systems, but these are expensive. Carrying out the laser measurements in a vacuum can eliminate the noise altogether, but again this can be costly or impractical.

The elimination or reduction of air turbulence induced noise from laser interferometer measurements is becoming increasingly important in electronics and semiconductor manufacturing as tolerances are tightened, feature sizes shrink and wafer/panel sizes grow. The throughput requirements of this sector also dictate that any techniques for reduction of this noise must work in dynamic applications, i.e. where the position of a moving object is to be measured.

The dominant cause of air turbulence induced noise on laser interferometer readings is small fluctuations in the temperature of the air through which the laser beam passes. These changes in temperature alter the air's refractive index and hence the laser beam's optical path length. The effect of air temperature on air refractive index is known and is modelled by, for example, the Edlen equation (Kaye & Laby Tables of Physical and Chemical Constants 16^{th} Edition Page 130). Under normal atmospheric conditions the refractive index of air decreases by about 0.96 ppm for each 1 degree Celsius rise in air temperature. The Edlen equation shows that the refractive index of air is also affected by other parameters such as air pressure, humidity and CO₂ content. However, short-term localised fluctuations in air temperature are the main cause of air turbulence induced noise. The other parameters either vary very slowly (e.g. atmospheric pressure) or have little effect on the refractive index (e.g. air humidity or CO₂ content). Work at Lawrence Livermore by Bryan and Carter (“Straightness Metrology Applied to a 100 inch creep feed grinder” 5^{th} International Precision Engineering Seminar Monterey Calif. 1989) refers to this air turbulence induced noise as “micro thermal noise”. Their work showed that air turbulence noise can be reduced by homogenising the air using a fan and diffusing mesh to unify the temperature both temporally and spatially; see U.S. Pat. No. 5,141,318. However, the technique is not completely effective and cannot always be employed due to space constraints.

If the temperature of air changes by 0.1° C. then its refractive index changes by about 0.096 ppm, which increases the laser wavelength and thereby decreases the laser reading by about 0.096 ppm. Air turbulence induced noise typically appears as a fluctuation of the laser position readout with a magnitude anywhere from ±0.1 ppm (in a thermally stable environment) up to ±5 ppm (in a thermally unstable environment). Typically this fluctuation appears as a random “meandering” of the laser position readout with a frequency spectrum ranging anywhere from 0.01 Hz to 100 Hz. In addition to temporal variations, air temperature fluctuations are also spatially variant. Air in one location may be thermally stable whereas air a short distance away maybe thermally unstable, even though the average air temperature of both areas is equivalent.

It is also known to use air temperature sensors (based on thermistors, thermocouples or other suitable sensing elements) to provide air refraction variation compensation as described in U.S. Pat. No. 3,520,613. However, this approach can only compensate for relatively slow changes in the environment and it is not suitable for air turbulence noise elimination for two reasons. Firstly air temperature sensors of this nature do not respond quickly enough to measure the more rapid changes in air temperature that contribute to air turbulence induced noise. Secondly such sensors only respond to the temperature of the air in their immediate vicinity, which is unlikely to match the air temperature variations along the actual measuring laser beam.

If a laser interferometer is set up over a fixed length reference path that is open to the air then the laser can be used to measure the refractive index variations of the air inside the reference path since they will cause the optical path length to vary. A so-called “refractometer” or wavelength tracker is described in U.S. Pat. No. 4,765,741 that can measure variations in refractive index extremely quickly and so can track the rapid changes in air temperature that can contribute to air turbulence induced noise. However, tracking refractometers are expensive and again can only respond to variations of refractive index of the air inside them, which are unlikely to match the air temperature variations along the measurement laser beam.

Because the refractive index of air also depends on the wavelength of the light passing through it (due to the dispersion effect) it is possible to set up two laser interferometers with differing wavelengths measuring over the same path at the same time. It is then possible to process the two laser readings to isolate genuine changes in measured path length from apparent changes induced by variations in refractive index. This is described in U.S. Pat. No. 6,327,039. However, the dispersion effect is very small so the relationship between the two laser wavelengths must be precisely known. This is expensive to achieve.

It is also known that the velocity of sound in air is temperature dependent. It is therefore possible to use the transit time of a sound pulse over a known distance to determine the temperature of the air in this path; for example, see U.S. Pat. No. 4,201,087 and U.S. Pat. No. 5,624,188. Since air turbulence induced noise is predominantly a temperature effect this technique can be used to reduce air turbulence noise in laser position readings. A system of this nature is described in U.S. Pat. No. 6,501,550. Such a method has a sufficiently fast response time to detect the rapid changes in air temperature that can contribute to air turbulence induced noise and also can be arranged to measure along a path that is closely coincident with that of the laser beams. In normal atmospheric conditions it can be shown that the velocity of sound in air decreases by around 1800 ppm/C. The Edlen equation (referred to above) shows that the refractive index of air, under normal laboratory conditions, decreases by 0.96 ppm/deg C. It is therefore possible to compensate for air temperature fluctuations by adjusting the laser readings by 1/1800/0.96 which is around 1/1875 times the fluctuation in the velocity of sound.

According to a first aspect of the present invention, measurement apparatus comprises: a laser measuring system providing laser measurements of a moveable object relative to a reference object; means for providing a machine feedback control signal for controlling movement of the moveable object relative to the reference object; an acoustic system which transmits sound between the moveable object and the reference object and outputs time of flight values indicative of the time of flight of sound passing between the moveable object and the reference object; a compensation system which uses the output of the acoustic system to compensate the laser measurements to generate compensated laser measurements, wherein the laser measurements are generated at a rate greater than the rate of generation of the time of flight values and the update rate of the machine feedback control signal is greater than the rate of generation of the time of flight values, characterised in that the compensation system generates each compensated laser measurement using a compensation value derived from a plurality of laser measurements and at least one time of flight value.

The present invention thus provides measurement apparatus that includes a laser measuring system (e.g. a laser interferometer or other suitable laser device) for measuring a moveable object relative to a reference object (e.g. a reflector). Advantageously, the laser measuring system provides laser measurements of the position and/or velocity of the movable object relative to the reference object. Apparatus of the present invention also comprises an acoustic system for measuring the time of flight of sound between the moveable object and the reference object thereby allowing time of flight values to be measured that are indicative of the time of flight of sound passing between the moveable and reference object. A compensation system is also provided that uses the time of flight values to provide compensated laser measurements. The apparatus also provides means for providing a machine feedback control signal (e.g. a positional information signal) that can be fed to the control loop of an associated machine. This machine feedback control signal is derived from the compensated laser measurements and may be updated at the same rate, or at a different rate, to the rate of producing laser measurements.

At this point, the physics underlying the measurement apparatus of the present invention should be noted. The laser measuring system can provide precise measurements of the optical path length of the system (e.g. the separation of the moveable and reference objects). A value indicative of the time of flight of sound along substantially the same path can also be derived from the acoustic system. The combination of the known acoustic time of flight value and the known (optical) path length value allows the spatial mean average value of sound velocity along the path to be found. From the spatial mean average value of the velocity of sound it is possible to derive the spatial mean temperature of air along the path which in turn permits the spatial mean refractive index of air along the path to be obtained. Knowing the spatial mean refractive index of air along the path permits compensation of the laser measurements thus providing the compensated laser measurements. It should also be noted that where improvements in precision are required, the apparatus need not explicitly calculate each of the above values in turn but the general principles underlying the invention will be based on the above mentioned physical interrelationships.

The present inventors have found that whilst prior art systems of the type described above (e.g. in U.S. Pat. No. 6,501,550) can provide adequate air turbulence noise reduction under static conditions, their performance decreases in dynamic applications (e.g. where the position of a moving object is to be measured). The present invention mitigates such performance degradation problems and permits air turbulence noise reduction for dynamic systems. In particular, the present invention provides apparatus in which the optical path length data derived from the laser measuring system more closely corresponds to the time of flight data of the acoustic system, even when there is relative motion between the reference and moveable objects. This is achieved by the compensation system generating each compensated laser measurement from the initial laser measurement using a compensation value (e.g. a compensation factor) derived from a plurality of laser measurements (rather than one laser measurement as described in the prior art) and at least one acoustic measurement; this is described in more detail below. This allows improved laser measurement compensation in apparatus where there is continuous motion of the moveable object relative to the reference object such that the path length (both optical and acoustic) varies continuously during use. The feedback control signal thus allows feedback control to be established for substantially real time operation.

There are many examples of dynamic applications that can benefit from apparatus of the present invention. For example, modern position feedback servo-control loops used in the semiconductor/electronics industries often rely on servo-loop update rates in excess of 10 kHz and sometimes as high as several MHz. Such systems also require latency variations (i.e. variations in the time delay between actual position and reported position readout) of less than 10 ns. These high update rates and low latency variations are required to ensure that the motion control system can maintain position control at the nanometre level whilst the axis may be moving at many millimetres per second, such are the tolerances and throughput rates of these industries. Laser interferometer systems can provide the necessary position readout resolutions (sub-nanometre) and update rates (several MHz). The axis lengths of these machines typically range from 300 mm (Silicon wafer) to 3000 mm (large flat panel display) and the velocity of sound in air is around 300 m/s. This means that the round trip transit time of a sound pulse along the full axis can take anywhere from 2 to 20 milliseconds. Consequently, the update rate of a system which sends a single sound pulse and then waits for the echo is at best between 50 Hz-500 Hz depending on axis length. It is possible to increase this by, for example, sending a second pulse whilst waiting for the echo from the first pulse, but this technique quickly causes problems as the noise of subsequent pulses and stray echoes mix with the original sound pulse making separation of the various signals problematic.

The present invention provides a system for air turbulence noise reduction that provides the fast update rate and minimal latency variation required for servo-control applications, whilst utilising the relatively slow update data from an acoustic transit (time of flight) time signal. In other words, the acoustic time of flight data values are used to correct the laser measurements without limiting the rate at which compensated laser measurement values can be generated.

Advantageously, the compensation system determines each compensation value using an interpolation process that comprises interpolating between a plurality of laser measurements. The interpolation may conveniently be a linear interpolation or it may be performed by fitting a polynomial equation to said plurality of laser measurements. The interpolation process may advantageously involve calculating interpolated laser measurements to estimate a path length associated with each of the time of flight values. As an alternative to interpolation, an extrapolation process may be performed to similar effect.

Conveniently, the compensation system varies said compensation value smoothly with time. For example a linear interpolation may be performed at the transition between compensation values. This ensures that there are no sudden changes in the feedback control signal that is provided to the associated movement controller. Techniques for ensuring such a smooth variation are described in more detail below.

Advantageously, the compensation system estimates future compensation values by extrapolation from measured compensation values. In other words, the compensation values applied to the laser interferometer measurements are “look ahead” values determined by extrapolating previously calculated compensation values. This reduces any lag associated with calculating the compensation values with which the laser measurements are converted into compensated laser measurements. Such a “look ahead” technique can also reduce any step changes in compensation value that may otherwise occur.

The moveable object may comprise an optical reflector, such as a mirror. The moveable object may comprise a stage or the like of an associated machine.

The acoustic system may be configured to generate sound of any frequency, however the acoustic system conveniently transmits ultra-sound. To prevent multi-path effects, the acoustic system preferably transmits pulses of sound.

The acoustic system advantageously comprises at least one acoustic transmitter and at least one acoustic receiver. Transmitters and receivers may be located as required on either or both of the moveable and reference objects. Although separate transmitters and receivers can be provided, the use of combined transmitter/receiver (transceiver) components is also possible.

Conveniently, an acoustic transmitter and an acoustic receiver are attached to said reference object and sound is passed from the acoustic transmitter to the acoustic receiver via reflection from the moveable object. The moveable object conveniently carries an acoustic transmitter that transmits sound to an acoustic receiver carried by the reference object. Advantageously, the reference object carries an acoustic transmitter that transmits a beam of sound to an acoustic receiver carried by the moveable object.

To maximise correspondence between the optical and acoustic system, the sound beam(s) of the acoustic system are preferably substantially parallel to the laser beam(s) of the laser measuring system.

According to a second aspect of the invention, a measurement method comprises the steps of;
(i) using a laser system to take laser measurements of a moveable object relative to a reference object,
(ii) generating a machine feedback control signal for controlling movement of the moveable object relative to the reference object,
(iii) using an acoustic system to transmit sound between the moveable object and the reference object to generate time of flight values indicative of the time of flight of sound passing between the moveable object and the reference object;
(iv) using the output of the acoustic system to compensate the laser measurements to generate compensated laser measurements,
wherein the laser measurements of step (i) are generated at a rate greater than the rate of generation of said time of flight values in step (iii) and the machine feedback control signal of step (ii) is updated at a rate greater than the rate of generation of said time of flight values in step (iii),
characterised in that and in that step (iv) comprises using a compensation value derived from a plurality of laser measurements and at least one time of flight value.

A measurement apparatus is also described herein that comprises: a laser measurement system (e.g. a laser interferometer) providing laser measurements of a moveable object relative to a reference object; an acoustic system (e.g. an acoustic ranging system) which transmits sound between the movable object and the reference object and outputs time of flight values indicative of the time of flight of sound passing between the moveable object and the reference object; a compensation system which uses the output of the acoustic system to compensate the laser measurements to generate compensated laser measurements; wherein the compensation system generates each compensated laser measurement using a compensation value derived from a plurality of laser measurements and at least one time of flight (i.e. acoustic) value.

The invention will now be described, by way of example only, with reference to the accompanying drawings, wherein:

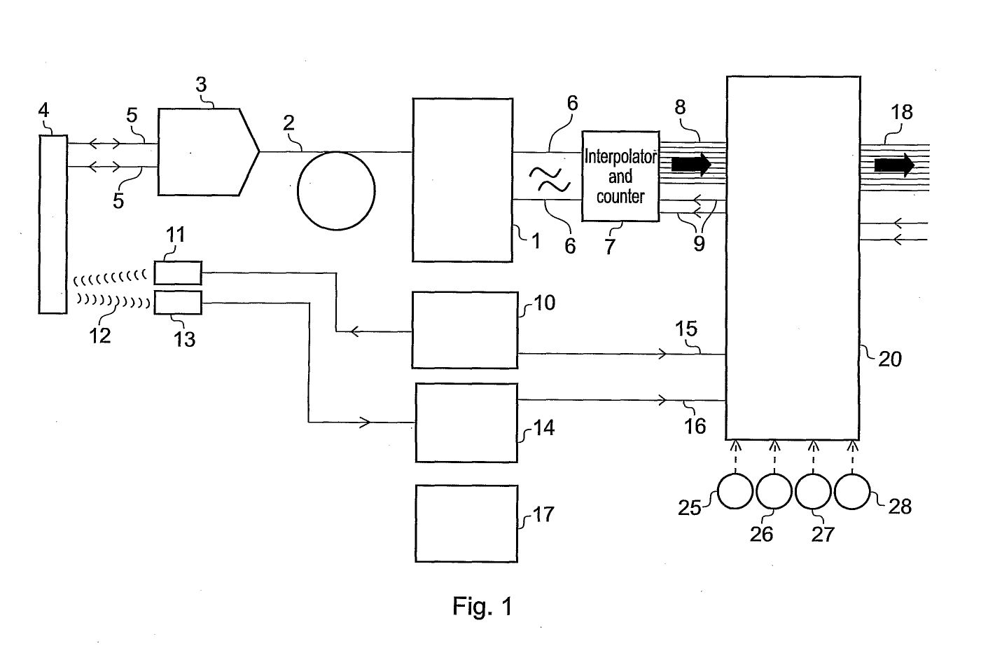

FIG. 1 is a diagrammatic overview of a first embodiment of a laser interferometer based system of the present invention;

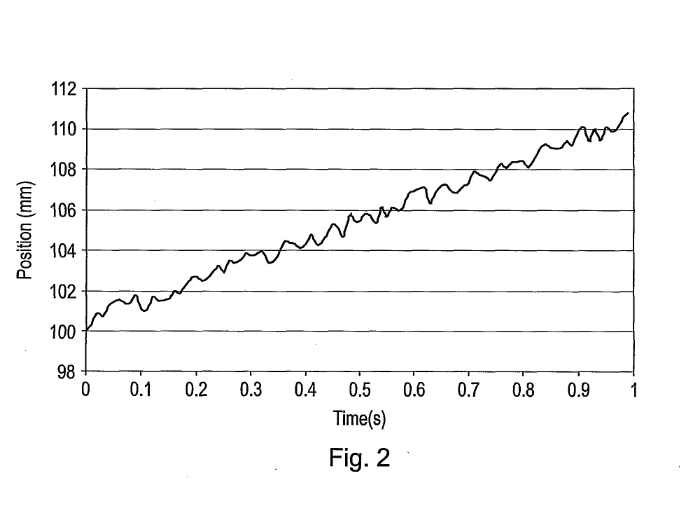

FIG. 2 is a graph of uncompensated laser position readings versus time;

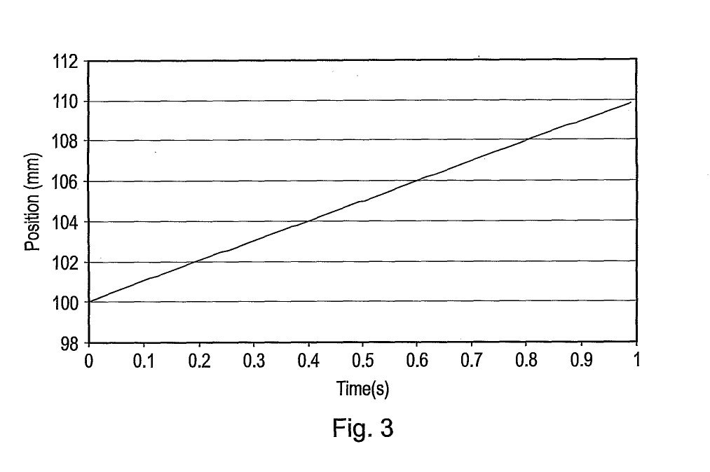

FIG. 3 is a graph of compensated laser position readings versus time;

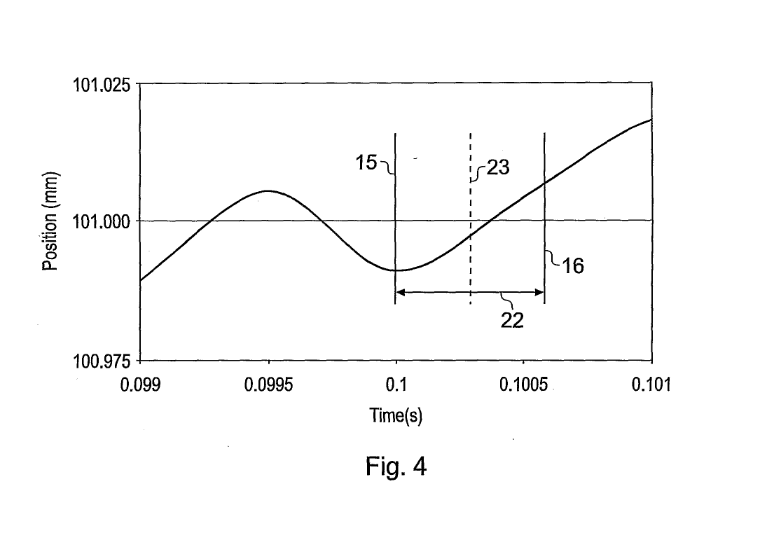

FIGS. 4,5 and 6 are expanded views of the uncompensated readings of FIG. 2;

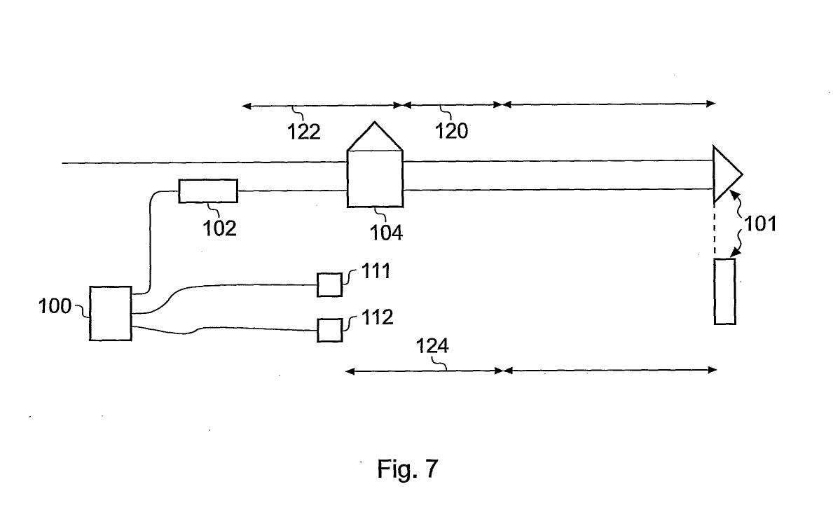

FIG. 7 illustrates the effect of additional timing delays;

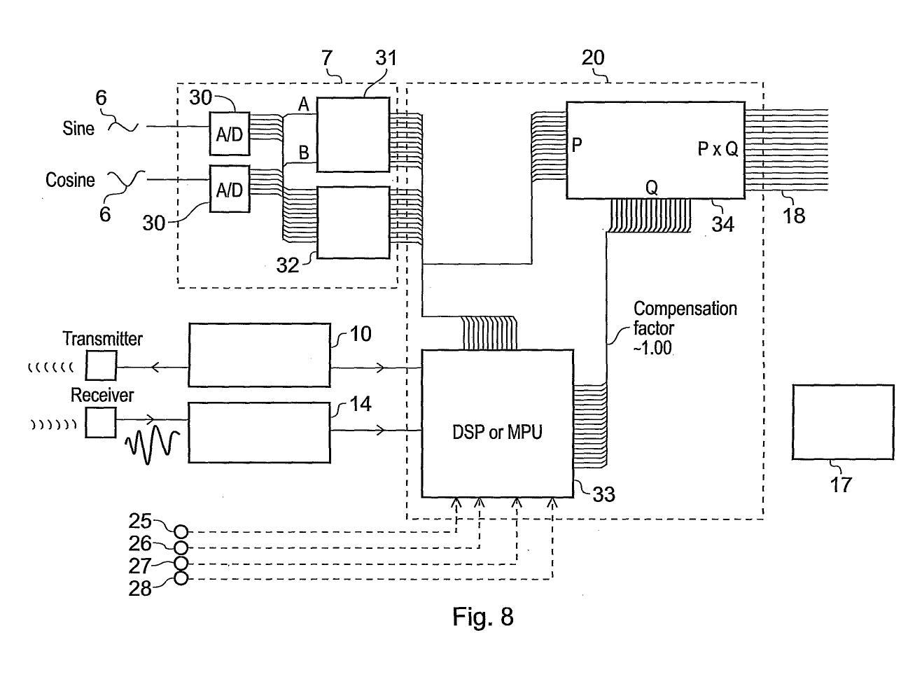

FIG. 8 is a more detailed view of parts of the laser interferometer system; and

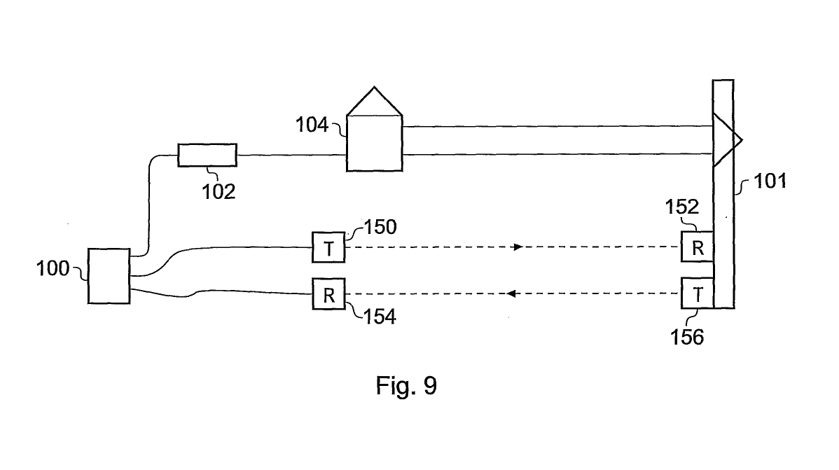

FIG. 9 shows an alternative embodiment of the present invention.

Referring to FIG. 1 an overview of measurement apparatus of the present invention is shown.

The measurement apparatus comprises a laser interferometer system comprising a laser source 1, an electro-optical link cable 2 and a combined interferometer and fringe detector 3. The combined interference and fringe detector 3 is optically linked to the laser 1 via the cable 2 and is arranged to measure the change in position of a moving reflector 4 using outward and return laser beams 5. Reflector 4 is typically affixed to the movable stage of a motion system (not shown) and is typically a plane mirror. This mirror forms the reflector in the measurement arm of a conventional double-beam, double-pass, plane-mirror interferometer.

Changes in the position of the reflector 4 are detected as changes in the length of the path of laser beams 5 which then cause the generation of light and dark fringes in the interferometer which are detected using photo-detectors in the fringe detector unit 3. After processing these signals appear as electrical sine and cosine position feedback signals 6 also known as analogue quadrature signals. Typically one cycle (the period) of the sine and cosine signal occurs every time the reflector 4 moves by a distance equivalent to ¼ of the wavelength of the laser light. A red laser with a wavelength of 633 nm gives a period of about 158 nm. These signals 6 are continuous real time, analogue voltage signals that respond within a few tens of nanoseconds of reflector movement.

The signals 6 are then fed to an interpolator and counter circuit 7 which converts the analogue signals into a digital position reading which changes as the mirror moves. Typically the digital output value is zeroed, using one of the control signals 9, when the moving reflector 4 is close to the interferometer 3. The subsequent digital output value 8 on a 40 bit parallel bus then varies in proportion to the separation between reflector 4 and interferometer 3. The interpolator provides a very high resolution position reading (sub-nanometre) which is updated at a very high rate (typically around 5 MHz), in response to pulses from a master clock 17, with a latency variation of a few nanoseconds. The detailed operation of the interpolator and counter circuit is described in more detail below.

The digital position readings on the bus 8 have resolutions and update rates that are ideally suited to high-resolution dynamic servo-loop control applications. However, these laser position readings not only vary as the mirror moves, they also vary if the temperature of the air through which laser beams 5 pass varies since this will cause the laser's wavelength to vary slightly. This variation is the air turbulence induced noise described above. The readings 8 are therefore referred to as “uncompensated” since compensation has not yet been applied to remove this induced noise. The uncompensated digital position readings 8 are fed to the real time position compensator 20. Although referred to as “uncompensated readings” for simplicity, it should be noted that such readings may have already been compensated to some extent by other parts of interferometer system. The terms compensated and uncompensated are used herein to define readings that have or have not been compensated in accordance with the present invention.

In parallel with the laser interferometer system an acoustic system, which in this example is an acoustic ranging system, is arranged to generate sound pulses at known times and determine the arrival time of their echoes which have traveled through nominally the same air as the laser beams 5.

The acoustic ranging system comprises the following elements. An electronic circuit 10 that periodically generates an electronic pulse waveform that drives an ultrasonic transmitter 11 to generate a sound pulse 12. The sound pulse 12 travels from the transmitter 11 to the reflector 4 and back to an ultrasonic receiver 13. The period between pulses will typically be of the order of 1/100^{th} second to allow echoes from the previous pulse to disappear before the next pulse is transmitted on axes up to 1 metre long. Preferably, the sound pulse or burst has a fast rise time, so that the receiver is better able to distinguish it from stray reflections. For example, it may be generated by an electrical discharge.

The ultrasonic transmitter 11 and receiver 13 are arranged so that the sound pulse travels through air as close as practical to the laser beams 5 and is reflected by a similar point on the reflector 4. The pulse generator circuit 10 also records the time at which the pulse was transmitted, based on signals from master clock 17 and sends this information to the real time position compensator system 20. The signal from the receiver is analysed by echo detection electronics 14 to determine when the echo arrives and records the time at which this occurs based on signals from the master clock 17, this information is transmitted to the real time position compensator 20.

The real time position compensator 20 therefore receives sound pulse transit time information (i.e., time of flight date) at a relatively low update rate (e.g. around 100 Hz) and laser interferometer position data at a very high rate (˜5 MHz). In accordance with the present invention the real time position compensator 20 produces compensated digital position values 21 at the rate required by very high-speed servo loops of around 1 MHz. The detailed operation of the real time compensator 20 is described in more detail below, but the nature of the data and signals arriving at real time position compensator will first be described in more detail with reference to FIGS. 2 and 3.

As mentioned above, the laser interferometer provides position versus time data at a high rate. FIG. 2 shows a graph of such data taken over 1 second as the axis (and hence reflector) are moving at a constant 10 mm/second. The data is uncompensated and so contains air turbulence induced noise as shown by the wiggles on the graph. It is the objective of the real time compensator to compensate for any air turbulence thereby eliminating this noise. A trace of compensated laser position readings would thus look like that shown in FIG. 3. Note that the difference in the appearances of the traces of FIGS. 2 and 3 has been exaggerated for clarity; in reality the air turbulence induced noise is 1,000 times smaller than that shown. Note also that the graphs in FIGS. 2 and 3 contain around 5 million laser readings each so, at this scale, the individual laser readings are not visible.

FIG. 4 shows an expanded view of the data presented in FIG. 2. The solid vertical lines on the trace indicate the time of sound pulse transmission 15, and the time of receipt of the echo 16. The round trip time of the sound pulse 22 is given by subtracting the time of pulse transmission 15 from the time of echo receipt 16. For accurate compensation, in dynamic applications it is necessary to know the laser reading at the exact instant the sound wave struck the reflector, since this allows the precise distance the sound wave has traveled to be identified. If the reflector 4 was stationary, then this is straightforward. However, in dynamic applications the stage is moving and the laser reading is varying (as shown in FIG. 4), so the process is more complicated.

It can be shown that the time taken for the sound pulse to reach the reflector and the time taken to travel back will be equal (providing the line through active points of the transmitter and receiver is arranged to be parallel to the reflector surface). There is a small effect if there is a breeze blowing towards or away from the reflector. But, relative to the velocity of sound of around 340 m/s, the effect of this can be ignored for breeze velocities below about 1 m/s. Therefore the instant the sound wave strikes the mirror can be taken as being mid-point between the time of pulse transmission 15 and echo receipt 16, this is shown by the dotted line 23 in FIG. 4.

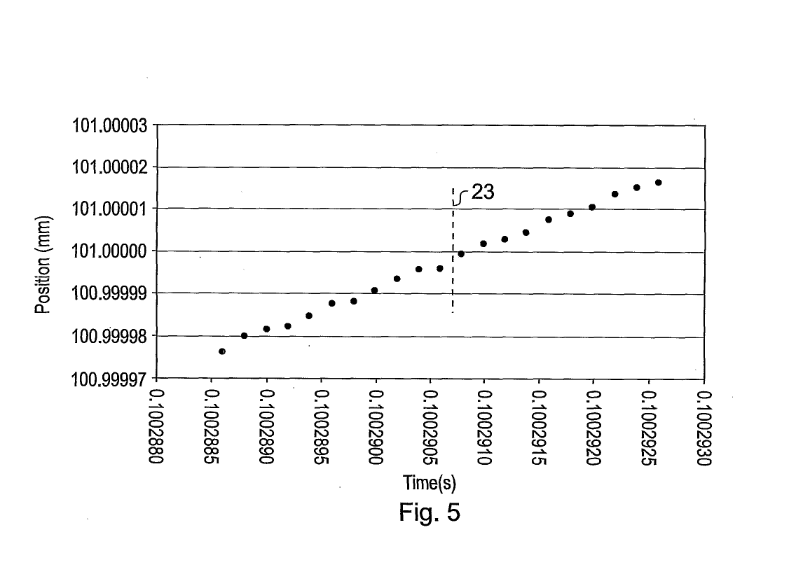

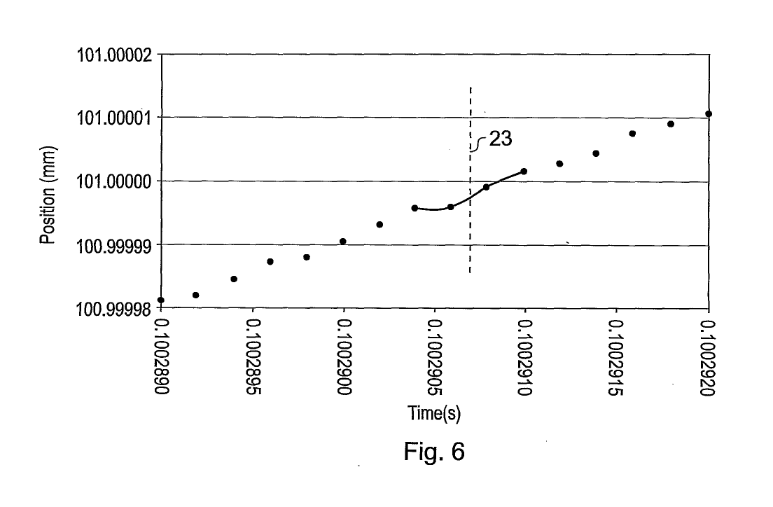

Having calculated the time at which the sound wave struck the reflector, it is necessary to calculate the laser reading at that same instant. This is carried out as follows. The uncompensated laser position readings 8 from the interpolator and counter circuit 7 are updated at around 5 MHz. The real time position compensator 20 stores these readings and the times at which they were recorded. Then, once the echo has been received, it calculates the mid-time between pulse transmission and echo receipt to give the reflector strike time 23, and then examines the laser readings it recorded around that time. This is shown schematically in FIGS. 5 and 6.

FIG. 5 shows the laser readings that have been recorded around the reflector strike time 23. It is unlikely that there will be a recorded laser reading coinciding with the instant of strike (since the two processes are independent and hence are asynchronous). Therefore, in order to achieve an accurate value of the laser position reading it is convenient to estimate the laser reading at the instant of reflector strike. This can be done by linear interpolation between the laser position reading immediately before the instant of strike and that immediately after. However, for higher accuracy it is desirable to fit a polynomial equation to a number of points around the strike time (as shown in FIG. 6) and then solve for the value of the laser reading at the instant of strike. Bearing in mind the need to minimise any delays in the system it is important to calculate the laser position as quickly as possible. This can be achieved efficiently using a technique called LeGrange polynomial interpolation (ref. I. N. Bronshtein, K. A. Semendyayev Handbook of Mathematics, Mathematica etc.). These calculations may be modified to take into account the small delays within the signal processing electronics and due to the transit times of the laser beams. Other interpolation techniques may alternatively be used.

Having obtained the laser reading at the time of strike and the round trip time 22 for the sound pulse, it is possible to process this data in order to reduce air turbulence induced noise and optionally to improve the accuracy of the results.

A method of air turbulence noise reduction of the present invention may be implemented as follows. Firstly, the reflector is 1 moved to the furthest position along the axis. It is then possible to establish a baseline ratio between the uncompensated laser reading at the time of strike and the sound round trip time, by dividing one into the other. The air turbulence noise reduction process can then start. The round trip time of each subsequent acoustic pulse is divided into the uncompensated laser position reading at the respective time of reflector strike to give a new ratio. Any deviation from the previously calculated baseline ratio is then used to derive a compensation factor which can be used to calculate a compensated laser position reading.

Taking a specific example, suppose the reflector is moved to the far end of the axis at which position the acoustic round trip time is determined to be 1.744186 ms and the uncompensated laser reading at the time of strike is found to be 301.411265 mm. The baseline ratio is therefore 172.8091299 mm/ms. The reflector then moves to another position and the air temperature may have fluctuated slightly. At this new position the acoustic round trip time is determined to be 1.395349 ms and the uncompensated laser reading at the time of strike is found to be 241.179890 mm. The new ratio is therefore 172.8455677 mm/mS. This new ratio is 210.8557 ppm larger than the baseline ratio. This indicates that the average air temperature has fallen by 210.8557/1800=0.116 deg C. Therefore the correction required to the uncompensated laser reading is −0.116 ×0.96=−0.111 ppm. The compensated laser reading is therefore 241.1798631 mm. This process can be repeated indefinitely, thereby reducing air turbulence induced noise due to short-term variations in air temperature.

It should be noted that the constants in the above calculation (0.96 ppm and around 1800) apply at normal atmospheric pressure (101,325 nm⁻²), temperature (20° C.) and humidity (50% RH). For improved compensation, these constants may be adjusted slightly using the Edlen equation and Cramer equation (Journal of The Acoustic Society of America 93, 1993, 2510-2516) if the atmospheric conditions are different to those stated. As mentioned below these values may be periodically measured if high accuracy is required.

Referring to FIG. 7, the effect of dead paths and other timing delays in the system will be described. In particular, FIG. 7 provides a top-level illustration of measurement apparatus of the present invention. The measurement apparatus thus comprises control electronics 100 for controlling the laser 103 and the associated interference and fringe detector 104 of the interferometer. Furthermore, the electronics 100 provides the signal to be transmitted by transmitter 111 and also receives the signal detected by the acoustic detector 112. The optical and acoustic reflector 101 which is moveable relative to the remainder of the apparatus is also shown.

It can thus be seen that a number of factors can be taken into account when attempting to match timings of optical and acoustic signals. For example, it may be wished to take into account the optical dead path 120 and any additional optical paths 122 in the system. Similarly, the acoustic optical dead path 124 may also be taken into account. An air dead path refers to the laser or acoustic path between interferometer and reflector or transmitter and receiver when the system is zeroed.

Consideration may also be given to the electronic transit times of the various electrical signals of the apparatus. For example, the time it takes for signal to pass through and from the interferometer detection unit to the coincidence timer. In the acoustic system, the time it takes to initiate the electrical pulse, the delay associated with the signal passing to the acoustic transmitter and the time delay of the acoustic generator to produce the sound pulse may be accounted for. Furthermore, the time delay of the acoustic receiver to detect the sound pulse and the time it takes for this signal to pass to the coincidence timer may also be corrected for.

It should also be noted that if the optical dead path is taken into account when computing the refractive index, then the change in refractive index is preferably applied to both the measured optical path length and the optical dead path.

If required, it can thus be seen that the various calculations outlined above can be modified to take into account air “dead paths” and/or timing delays in the system. This can be done either by adding predefined offsets to all laser readings and acoustic transit times before calculating the ratios, or by making a baseline ratio measurement at both ends of the axis (reflector) travel and then linearly interpolating between them. The quality of the baseline ratio measurement may also be improved by taking a number of measurements at each location and averaging them.

The compensation method described above is suitable for removing the effects of short term air temperature variations, but it does not correct for the absolute temperature or for the air pressure, humidity or CO₂ levels. Measurement accuracy may thus be further improved by also performing air refraction compensation using conventional environmental sensors. For example, sensors 25, 26, 27 and 28 as shown in FIG. 1 can be used periodically to measure the current air temperature, pressure, humidity and CO₂ levels. These can be substituted into the above-mentioned Edlen equation in order to determine the current air refractive index and to thereby calculate a compensation factor, which can then be applied to the laser readings. This initial correction will improve the accuracy of the laser position readings. However, due to the relatively slow response time of the conventional air sensor (and it's location) this compensation factor will not compensate for the rapid air temperature fluctuations along the laser beams which are the cause of the air turbulence induced noise. To overcome this, the compensation factor is adjusted, using the results from deviation from baseline ratio calculation as described above. So, for example, if the Edlen equation generates a laser compensation factor of +51.000 ppm and the ratio calculation shows a deviation from baseline ratio of −0.11 ppm, (as per the example given above) then the combined correction required is +50.889 ppm.

The air turbulence noise reduction and air fraction compensation process can both be repeated indefinitely thereby reducing air turbulence induced noise from short-term variations in air temperature whilst also improving long term accuracy by eliminating longer term variations due to changes in air pressure, humidity and CO2 levels.

It should be understood that, depending on the accuracy level required, the environmental sensors described above may be replaced with fixed values. For example, a significant influence on air pressure is altitude. So instead of utilising a pressure sensor a single calculated pressure value may be used based, for example, upon the geographic location of the system. However, such a system would not compensate for the day to day variations in atmospheric pressure caused by the weather.

A method of deriving the compensation factors (in accordance with the present invention) to produce compensated laser readings is described above. However, the rate at which these compensation factors are updated is relatively slow (i.e. after each sound pulse is received). This was previously thought to cause a delay in the compensation process and thus restrict the rate of generation of compensated measurements to the rate of generation of sound pulses (e.g. to around 100 Hz or so). Referring to FIG. 8, it will now be described how real time compensated positions can be produced with an update rate in excess of 1 MHz, how compensation can be updated smoothly and how a “look ahead” correction can be applied to reduce the error in compensation. In other words, FIG. 8 provides a more detailed description of the interpolator and counter 7 and real time position compensator 20 elements described above with reference to FIG. 1.

Interpolation and counting is carried out by the interpolator and counter 7 by first digitising the sine and cosine signals from the laser interferometer using fast A/D converters 30. For example these, convertors could each produce 8 bit digitised sine and cosine values at an update rate around 50 MHz. The most significant bit (MSB) of each A/D changes state at the sine and cosine “zero crossings” to produce A and B “digital quadrature signals” that are used to drive a synchronous up down counter 31. The lower output bits of each A/D converter provide the address line inputs to an EPROM memory 32. The contents of each memory location in the EPROM have been pre-programmed with the interpolated phase angle corresponding to each combination of sine and cosine values that can be applied to its address inputs. When a digitised sine and cosine value is applied to the address input lines, the interpolated result appears as, say, an 8-bit result on the EPROM's data output lines. The output of the counter and interpolator may be sampled at around 5 MHz and placed on the interpolator and counter output data bus as uncompensated 40 bit parallel position readings 18.

The real time position compensator contains a microprocessor (MPU) or digital signal processor (DSP) 33. This is responsible for reading the uncompensated laser position readings from the bus, the current timings from the master clock, and for receiving the times when the acoustic pulses are generated and the echoes are received and for reading the data from any optional environmental sensors. The MPU or DSP then calculates a compensation factor (a number typically near 1) which is sent to the Q input of hardware multiplier 34.

Note that the number of uncompensated laser readings received between pulse transmission and echo receipt could be 100,000 or so. The system may therefore need a FIFO or dual port RAM memory to store all the values, allowing those taken around reflector strike time to be retrieved later. Alternatively, the DSP/MPU could predict when the reflector strike time is likely to occur (based on previous values) and only record the laser readings around that time, thereby reducing the storage requirement.

The hardware multiplier receives the uncompensated laser position readings on its P input (which is updated at about 5 MHz), and the compensation factor on its Q input. The hardware multiplier calculates P×Q and outputs the compensated laser position readings 18. The hardware multiplier produces a new result every time the P input value is updated (i.e. at about 5 MHz). The computation is carried out within 2 or 3 master clock cycles. The use of a hardware multiplier ensures that the update rate of the position feedback loop is not compromised and remains at 5 MHz and introduces only a few tens of nanoseconds of additional delay (latency) into the position feedback loop.

However if the MPU/DSP (33) only updates the compensation factor once (after each echo is received), then the P×Q output result produced by the hardware multiplier may show small steps in its output as the Q value is changed. The size of these steps can be reduced using additional calculations in the DSP/MPU, so that the compensation factor is applied as a series of smaller steps, by linear interpolation.

For example, suppose the first compensation factor calculated is 1.0001 and 1/100^{th} second later (after the next echo is received) the next compensation factor is calculated as 1.0002. Instead of changing the compensation factor by 0.0001 all in one go, the DSP/MPU (33) could instead update compensation factor it sends to the multiplier in ten steps of 0.00001 at 1/1000^{th} second intervals using a linear interpolation calculation. This will smooth out any steps in the output of the multiplier, resulting in smoother compensation.

However, this smoothing process introduces an additional delay into the compensation process. Instead of applying the additional 0.0001 compensation immediately, the system takes an additional 1/100^{th} second longer before the full compensation is applied. To overcome this the DSP/MPU can carry out “look ahead compensation”. This is done by fitting an equation to the last few compensation factors that have been calculated and then using this equation to predict (using extrapolation) the next expected compensation factor before the next echo has been received. These estimate values can be sent to the hardware multiplier (using smoothing if necessary) to reduce the compensation delay.

It should be noted that the apparatus and method described above is optimised for use with a homodyne laser system. However the principles described can also be applied to a heterodyne laser system. The interpolation and counting is carried out differently but can still produce a stream of laser position readings and timings. For example, in the case of a heterodyne laser system the laser position data shown in FIGS. 5 and 6 is more easily available at equal distance increments rather than equal time intervals. The LeGrange polynomial calculation of reflector strike time is therefore carried out in the time versus position domain, rather than the position versus time domain.

It will also be understood that the functions of the hardware multiplier and MPU/DSP can be implemented in a variety of ways including microprocessor, FPGA etc. It will thus also be understood that all these functions could in principle be carried out by a single DSP, providing it is fast enough, and providing the P×Q multiplication process is given the highest priority to minimise propagation delay and maximise update rate.

In addition, not all servo-control systems can accept parallel format position feedback signals and only accept analogue sine/cosine or digital A/B quadrature signals. In such an instance, compensated output readings 20 could be fed to a pulse or waveform synthesiser. The position reading provides the “demand position” and the pulse generator or wave synthesiser is servoed such that the output cycles and phase of the signals generated tracks the demand position. Normal PID and feed-forward servo-control algorithms may be used to minimise the delay between changes in demand position and the pulse or waveform output.

Also, it should be noted that the term “master clock” as used herein may be a stable high frequency digital square-wave generator, such as provided by quartz-crystal oscillators. All timings may therefore be made by simply counting cycles from this master clock. It should be noted that it is not necessary for this clock to be referenced to any real time clocks. The master clock preferably has a sufficiently high frequency and stability to provide the necessary timing precision, and advantageously all timings in the system are referred to the same master clock signal.

Although the above described examples employ a transmitter/receiver pair located on the interferometer that reflect sound from the moveable reflector, it should be noted that one or more receiver and/or one or more transmitter may be located on (and be moveable with) the reflector. An example of such an arrangement will now be described with reference to FIG. 9.

FIG. 9 schematically illustrates a further embodiment of the present invention. The measurement apparatus of FIG. 9 is broadly analogous to that described with reference to FIG. 7 above, except for the arrangement of the acoustic system. The acoustic system comprises a first receiver/transmitter pair having a fixed position transmitter 150 that can direct sound to a receiver 152 located on the moveable reflector 101. A second receiver/transmitter pair is also provided having a fixed position receiver 154 and an associated transmitted 156 located on the moveable reflector 101. A time of flight value can then be calculated using each receiver/transmitter pair and the average used to provide a time of flight value that mitigates the effect of any airflow in the gap.

It should be noted that the timing values used for comparison with the laser interferometry measurements are preferably different for the different receiver/transmitter pairs. In particular, the time of receipt of the sound pulse by the moving receiver 152 and the time of transmission of the sound pulse by the moving transmitter 156 should be used in the above described calculations. This ensures that the position of the moveable reflector as measured by the interferometer corresponds to the time of flight value measured acoustically. It should be noted that the provision of two receiver/transmitter pairs is only necessary where the effect of air flow are significant. If there is no significant airflow along the acoustic path, a single transducer pair may be sufficient.

1. A measurement apparatus comprising:
a laser measuring system providing laser measurements of a moveable object relative to a reference object;
means for providing a machine feedback control signal for controlling movement of the moveable object relative to the reference object;
an acoustic system which transmits sound between the moveable object and the reference object and outputs time of flight values indicative of the time of flight of sound passing between the moveable object and the reference object;
a compensation system which uses the output of the acoustic system to compensate the laser measurements to generate compensated laser measurements,
wherein the laser measurements are generated at a rate greater than the rate of generation of the time of flight values and the update rate of the machine feedback control signal is greater than the rate of generation of said time of flight values,
wherein that the compensation system generates each compensated laser measurement using a compensation value derived from a plurality of laser measurements and at least one time of flight value.

2. An apparatus according to claim 1 wherein the laser measuring system provides position measurements of the movable object relative to the reference object.

3. An apparatus according to claim 1 wherein the laser measuring system is a laser interferometer.

4. An apparatus according claim 1 wherein the compensation system determines each compensation value using an interpolation process that comprises interpolating between a plurality of laser measurements.

5. An apparatus according to claim 4, wherein the interpolation is a linear interpolation.

6. An apparatus according to claim 4, wherein the interpolation is performed by fitting a polynomial equation to said plurality of laser measurements.

7. An apparatus according to claim 4 wherein said interpolation process involves calculating interpolated laser measurements to estimate a path length associated with each of the time of flight values.

8. An apparatus according claim 1 wherein the compensation system varies said compensation value smoothly with time.

9. An apparatus according claim 1 wherein the compensation system estimates future compensation values by extrapolation from measured compensation values.

10. An apparatus according to claim 1 wherein the acoustic system transmits ultra-sound.

11. An apparatus according to claim 1 wherein the acoustic system transmits pulses of sound.

12. An apparatus according to claim 1 wherein the moveable object comprises an optical reflector.

13. An apparatus according to claim 1 wherein the acoustic system comprises at least one acoustic transmitter and at least one acoustic receiver.

14. An apparatus according to claim 13 wherein an acoustic transmitter and an acoustic receiver are attached to said reference object and sound is passed from the acoustic transmitter to the acoustic receiver via reflection from the moveable object.

15. An apparatus according to claim 13 wherein the moveable object carries an acoustic transmitter that transmits sound to an acoustic receiver carried by the reference object.

16. An apparatus according to claim 13 wherein the reference object carries an acoustic transmitter that transmits a beam of sound to an acoustic receiver carried by the moveable object.

17. An apparatus according to claim 1 wherein the sound beam(s) of the acoustic system are substantially parallel to the laser beam(s) of the laser measuring system.

18. An apparatus according to claim 1 wherein the generation of laser measurements is not synchronised with the generation of time of flight values.

19. An apparatus according to claim 1 wherein the feedback control signal allows feedback control to be established for substantially real time operation.

20. A measurement method comprising the steps of;
(i) using a laser system to take laser measurements of a moveable object relative to a reference object,
(ii) generating a machine feedback control signal for controlling movement of the moveable object relative to the reference object,
(iii) using an acoustic system to transmit sound between the moveable object and the reference object to generate time of flight values indicative of the time of flight of sound passing between the moveable object and the reference object;
(iv) using the output of the acoustic system to compensate the laser measurements to generate compensated laser measurements,
wherein the laser measurements of step (i) are generated at a rate greater than the rate of generation of said time of flight values in step (iii) and the machine feedback control signal of step (ii) is updated at a rate greater than the rate of generation of said time of flight values in step (iii),
wherein that and in that step (iv) comprises using a compensation value derived from a plurality of laser measurements and at least one time of flight value.
